(19) United States
(12) Patent Application Publication
(10) Pub. No.: US 2007/0216967 A1
(43) Pub. Date: Sep. 20, 2007

(54) Image scanning apparatus and image copying apparatus

(75) Inventor: Sueo Ueno, Shizuoka-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/378,609

(22) Filed: Mar. 17, 2006

(51) Int. Cl. H04N 1/04

(52) U.S. Cl. 358/486

(57) ABSTRACT

An image copying apparatus includes a scanner for scanning an image of a document and a printer for forming the image, the scanner has a document table for mounting a document to be an image scanning target, and a carriage mounting one of a contact image sensor and a module type reduced optical system thereon and moving in a secondary scanning direction when scanning an image of the document mounted on the document table in the scan of the image, and a series of sensors required for scanning an image in a primary scanning direction and the secondary scanning direction are mounted on the carriage. The image copying apparatus is possible to reduce a man-hour more greatly than that in the conventional art. Therefore, it is possible to contribute to a reduction in a cost and an enhancement in quality.

### BACKGROUND OF THE INVENTION

1. Technical Field of the Invention

The present invention relates to an image scanning apparatus and an image copying apparatus and more particularly to an image scanning apparatus and an image copying apparatus which contribute to a reduction in a cost and an enhancement in quality.

2. Related Art

In a conventional image scanning apparatus or an image scanning unit of an image copying apparatus, a contact image sensor (CIS) or a module type reduced optical system is previously assembled in an incorporation in a housing, thereby eliminating a regulation and decreasing an assembly man-hour.

In the conventional image scanning apparatus, however, a part of sensors required for scanning an image in a primary scanning direction (main scanning direction) and a secondary scanning direction (sub scanning direction) is also disposed on a body side (a housing side), and there is further room for reducing a cost and enhancing quality.

Therefore, there have been desired an image scanning apparatus and an image copying apparatus which contribute to a further reduction in a cost and a greater enhancement in quality as compared with the conventional art.

For the prior art in which the contact image sensor (CIS) or the module type reduced optical system has already been assembled in the incorporation in the housing to eliminate the regulation and to reduce the assembly man-hour, for example, there has been disclosed JP-A-11-150635.

### SUMMARY OF THE INVENTION

The invention has been made in consideration of the circumstances and has an object to provide an image scanning apparatus and an image copying apparatus which contribute to a further reduction in a cost and a greater enhancement in quality as compared with the conventional art.

An image scanning apparatus according to the invention comprises a document table for mounting a document to be an image scanning target, and a carriage mounting one of a contact image sensor and a module type reduced optical system thereon and moving in a secondary scanning direction when scanning an image of the document mounted on the document table in the scan of the image, and a series of sensors required for scanning an image in a primary scanning direction and the secondary scanning direction are mounted on the carriage.

An image copying apparatus according to the invention comprises a scanner for scanning an image of a document and a printer for forming the image, the scanner including a document table for mounting a document to be an image scanning target thereon, and a carriage mounting one of a contact image sensor and a module type reduced optical system thereon and moving in a secondary scanning direction when scanning an image of the document mounted on the document table in the scan of the image, and a series of sensors required for scanning an image in a primary scanning direction and the secondary scanning direction being mounted on the carriage.

According to the image scanning apparatus and the image copying apparatus in accordance with the invention, therefore, it is possible to reduce a man-hour more greatly than that in the conventional art. Consequently, it is possible to contribute to a reduction in a cost and an enhancement in quality.

### BRIEF DESCRIPTION OF THE DRAWINGS

In the accompanying drawings,

FIG. 1 is a view schematically showing a structure of an image copying apparatus according to the invention,

FIG. 2 is a schematic view showing a structure of a scanner in the image copying apparatus according to the invention, and

FIG. 3 is a view schematically showing a position on which a home position sensor is to be disposed in the image copying apparatus according to the invention.

### DETAILED DESCRIPTION OF PREFERRED EMBODIMENT

An embodiment of an image copying apparatus according to the invention will be described with reference to the accompanying drawings.

It is to be noted that terms indicating directions such as “up or down”, “left or right” and the likes are used herein with reference to actually used state (including a state illustrated on the drawings) of the apparatus if there is no particular explanation.

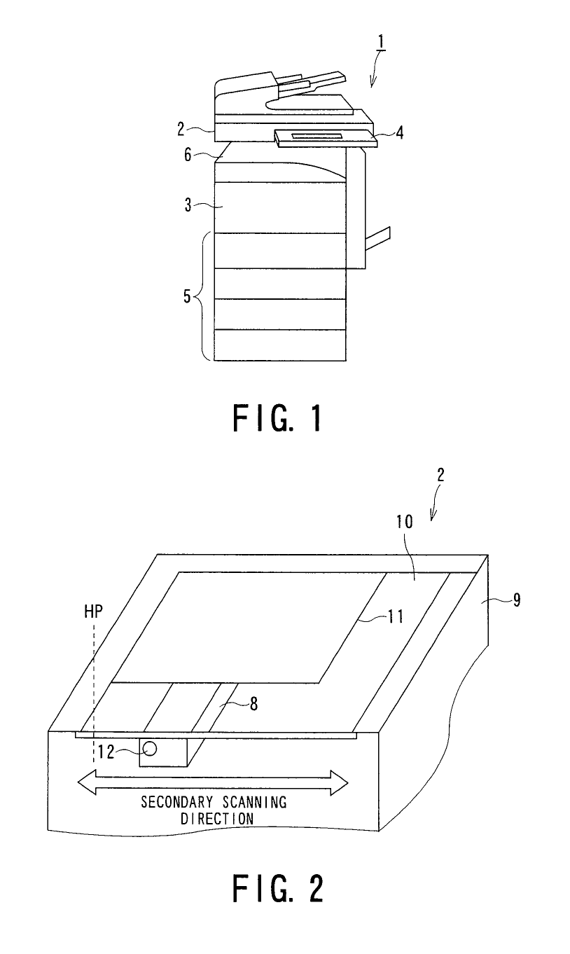

FIG. 1 is a view schematically showing a structure of an image copying apparatus 1 according to an example of the image copying apparatus in accordance with the invention.

The image copying apparatus 1 comprises a scanner 2 for scanning an image and a printer 3 for transferring a formed image to a paper and discharging the paper.

When receiving an image copying request of a user from a control panel 4 as a user interface, for example, the image copying apparatus 1 starts an image scan processing for a document mounted on a document table of the scanner 2. Information about an image scanned by the scanner 2 is transmitted to the printer 3 so that the scanned image is formed.

The printer 3 forms the scanned image and transfers and fixes the same image to a paper fed from a paper feeding unit 5, and then discharges the paper to a paper discharging unit 6.

In some cases, the scanner 2 does not transmit the information about the scanned image to the printer 3 but to a recording device or the likes which is not shown.

In some cases, moreover, information about the image formed by the printer 3 is received from an apparatus which is not shown other than the scanner 2 or is stored in the printer 3.

FIG. 2 is a schematic view showing a structure of the scanner 2 in the image copying apparatus 1.

The scanner 2 has a carriage 8 to be moved in a secondary scanning direction when scanning the image in a housing 9. The carriage 8 has an exposing lamp 12 for irradiating a light onto a document 11 mounted on a document table 10 when scanning the image. The carriage 8 is moved in the secondary scanning direction while irradiating the light from the exposing lamp 12 so that the document 11 mounted on the document table 10 is scanned.

The carriage 8 sets a home position (hereinafter referred to as an HP) to be a position reference in the secondary scanning direction, and a sensor for detecting that the carriage 8 is positioned in the HP (which will be hereinafter referred to as an HP sensor) is provided.

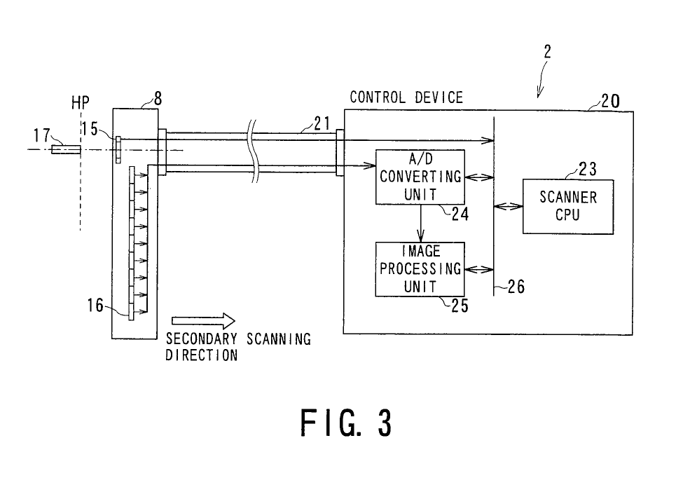

FIG. 3 is a view schematically showing a position in which an HP sensor 15 is to be disposed in the image copying apparatus 1.

The HP sensor 15 is mounted on the carriage 8 together with a CCD line sensor 16. The HP sensor 15 detects an HP detecting target 17 attached to the housing 9 side of the scanner 2, thereby detecting the HP. The HP sensor 15 outputs an HP detecting signal when detecting the HP.

The CCD line sensor 16 receives a light irradiated from the exposing lamp 12 and reflected from the document 11. The CCD line sensor 16 photoelectrically converts the received light and outputs an image signal.

The HP detecting target 17 is an optional component for shielding a detecting unit of the HP sensor 15 in the case in which the HP sensor 15 is constituted by a shielding type sensor. Moreover, the HP detecting target 17 is a mark in the case in which the HP sensor 15 is constituted by a reflecting type sensor.

The carriage 8 having the HP sensor 15 and the CCD line sensor 16 mounted thereon is connected to a control device 20 through a harness 21 for transmitting a signal. The harness 21 is constituted to be bendable in consideration of the fact that the carriage 8 is moved.

The HP detecting signal output from the HP sensor 15 and the image signal output from the CCD line sensor 16 are transmitted to the control device 20 through the harness 21.

The control device 20 includes a scanner CPU (Central Processing Unit) 23 for controlling the scanner 2, an A/D converting unit 24 for A/D (Analog to Digital) converting the image signal transmitted from the carriage 8, and an image processing unit 25 for signal processing an image signal obtained after the A/D conversion. The scanner CPU 23, the A/D converting unit 24 and the image processing unit 25 are connected through a bus 26 and can transfer and receive information mutually.

The scanner CPU 23 detects that the carriage 8 is placed in the HP upon receipt of the HP detecting signal output from the HP sensor 15.

In the image copying apparatus 1, the control device 20 can receive the HP detecting signal output from the HP sensor 15 and the image signal output from the CCD line sensor 16 through one kind of harness 21 connected to the carriage 8.

In consideration of the fact that the receipt is carried out through two kinds of harnesses including the harness to be connected to the carriage 8 and the harness to be connected to the HP sensor attached to the housing 9, conventionally, an assembling process corresponding to at least one kind of harness is reduced. Therefore, it is possible to contribute to a reduction in a cost which is obtained by decreasing an assembly man-hour and an enhancement in quality which is obtained by reducing the human errors of an assembly operator.

The invention is not exactly restricted to each of the embodiments but the components may be deformed to be concrete without departing from the scope thereof in an executing stage.

While the case of the image copying apparatus 1 comprising the scanner 2 has been described as an example of the invention, moreover, the case of the scanner 2 to be a single body (the image scanning apparatus) is also the same.

What is claimed is:

1. An image scanning apparatus comprising:
a document table configured to mount a document to be an image scanning target; and
a carriage mounting one of a contact image sensor and a module type reduced optical system thereon and moving in a secondary scanning direction when scanning an image of the document mounted on the document table in the scan of the image,
a series of sensors required for scanning an image in a primary scanning direction and the secondary scanning direction being mounted on the carriage.

2. The image scanning apparatus according to claim 1, wherein said sensors to be mounted on the carriage include a home position sensor for detecting a position reference in the secondary scanning direction of the carriage.

3. The image scanning apparatus according to claim 2, wherein a sensing target of the sensors to be mounted on the carriage is disposed in a housing.

4. The image scanning apparatus according to claim 2, wherein said home position sensor is a shielding type sensor or a reflecting type sensor.

5. An image copying apparatus comprising a scanner configured to scan an image of a document and a printer configured to form the image,
Wherein said scanner including a document table for mounting a document to be an image scanning target thereon, and
a carriage mounting one of a contact image sensor and a module type reduced optical system thereon and moving in a secondary scanning direction when scanning an image of the document mounted on the document table in the scan of the image, and
a series of sensors required for scanning an image in a primary scanning direction and the secondary scanning direction being mounted on the carriage.

6. The image copying apparatus according to claim 5, wherein said sensors to be mounted on the carriage include a home position sensor for detecting a position reference in the secondary scanning direction of the carriage.

7. The image copying apparatus according to claim 6, wherein a sensing target of the sensors to be mounted on the carriage is disposed in a housing.

8. The image copying apparatus according to claim 6, wherein said home position sensor is a shielding type sensor or a reflecting type sensor.
